(19) United States
(12) Patent Application Publication
(10) Pub. No.: US 2002/0035609 A1
(43) Pub. Date: Mar. 21, 2002

(54) Location bookmark system and method for creating and using location information

(76) Inventors: Jean-Sebastien Lessard, Verdun (CA); Mathieu Boisclair, Montreal (CA); Frederic Simard-Fournier, Montreal (CA)

Correspondence Address: Robert Brouillette, BROUILLETTE KOSIE, 25th Floor, 1100 Rene-Levesque Boulevard West, Montreal, QC, H3B 5C9, CA

(21) Appl. No.: 09/931,896

(22) Filed: Aug. 20, 2001

(30) Foreign Application Priority Data
Aug. 18, 2000 (CA) 2,316,417

(51) Int. Cl. G06F 15/16

(52) U.S. Cl. 709/217; 707/100

(57) ABSTRACT

This invention provides a system and method that enable wired and wireless computing device users to create, access and share geographical positioning data and related information preferably in real time. It allows for the creation, storage, access, transmission and management of geographical positioning data determined by GPS (or any other known method) coupled with other data such as text, images, audio and video which provides information, products and services relating to the said geographical positioning data. In a preferred embodiment, the system comprises a wireless positioning system and a wireless two-way data communication between a portable device and a network server. Said system and method allow users to integrate the use of location bookmarks in various applications.

### BACKGROUND OF THE INVENTION

1. Field of the Invention

This invention relates to distributed information systems, specifically those which create, share and retrieve information about places through users of wired and wireless computing devices.

2. General Discussion

Societal changes, marked by increasingly mobile life styles, greaterwork demands, and downsizing in business and government, have reduced people's free time. Most people in our increasingly connected society require greater information input and access in order to conduct their daily business.

People's need for information that specifically fits their personal and business needs has increased, hence the importance relating to availability, accessibility, and timeliness of this information about specific places, events, and their details. The current population is increasingly mobile, continues to travel more than in the past. Everyone needs ready information concerning events, conditions, and services about a place, particularly when it's unfamiliar. Solution to these problems is the ubiquitous portable device.

3. Description of Related Art

The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., web server or web site) to send graphical web pages of information to a remote client computer system. The remote client computer system can then display the web pages. Each resource (e.g., computer or web page) of the WWW is uniquely identifiable by a Uniform Resource Locator (“URL”). To view a specific web page, a client computer system specifies the URL for that web page in a request (e.g., a HyperText Transfer Protocol (“HTTP”) request). Currently, web pages are typically defined using HyperText Markup Language (“HTML”). HTML provides a standard set of tags that define how a web page is to be displayed.

The request is forwarded to the web server that supports that web page. When that web server receives the request, it sends that web page to the client computer system. When the client computer system receives that web page, it typically displays the web page using a browser. A browser is a special-purpose application program that effects the requesting of web pages and the displaying of web pages. Browsers typically allow user to store web page URL's as bookmarks.

Web browsers offer many options in the user interface for creating a bookmark list. Basic options let the user add and access a page through a pop-up menu on the location toolbar or through a pull down menu from the main menu bar. A simple way to add a bookmark for a favorite page is to enter the URL to travel to the page, once there, open the Bookmarks menu and choose the Add Bookmarks selection. This set of actions adds the URL of the current page as an item in the Bookmarks menu.

Once created, bookmarks offer a means of page retrieval. The user can cause the browser to display his bookmark list and select among his bookmarks to go directly to a favorite page. Thus, the user is not forced to enter a lengthy URL nor retrace the original tortuous route through the Internet by which he may have arrived at the web site. Once a bookmark is added to a bookmark list, in general, the bookmark becomes a permanent part of the browser until removed. The permanence and accessibility of bookmarks have made them a valuable means for personalizing a user's Internet access through the browser. Bookmarks are also used to inform the user when the sites to which the bookmarks refer have been modified.

For a more complete description of some prior art bookmark systems, see U.S. Pat. No. 5,895,471 (King & al) and U.S. Pat. No. 6,041,360 (Himmal & al).

There is a growing interest to provide access to hypermedia servers connected to networks such as the Internet through mobile devices, particularly hand held devices like wireless telephones. These devices are characterized by severe limitations in processing power, memory space, display size, and buttons or keys by which a user can request, view and manipulate information obtained from a hypermedia server. Furthermore, the bandwidth of the communication channels connecting the mobile devices to the rest of the network is also severely limited.

A wireless device has only a small fraction of the resources provided by a typical desktop or portable computer. Typically, the processing power is less than one percent of the processing power in many computers, the memory space is generally much less than 150 kilobytes (kB), and the display is perhaps four lines high and twelve or twenty characters wide. Graphics capabilities are very limited or nonexistent.

The communication path is often in the range of 2 400 to 36 000 bits per second but is intended to increase rapidly in the next decade. A new set of protocols (WAP, MeXe, HDTP, IEEE802.11) and markup languages (WML, HDML, XHTML) have been developed to provide WWW content to wireless devices.

There is also growing interest to provide to Internet applications, in local and wide area networks, the precise location of a wireless device user via indoor and outdoor positioning technologies, such as A-GPS, TOA, E-OTD, RFID or Bluetooth. These technologies will allow the usage of the real time position of a wireless device user for commercial purposes. Examples of these technologies are those based on: (1) two-way TOA and TDOA; (2) pattern recognition; (3) distributed antenna provisioning; (5) GPS signals, (6) angle of arrival, (7) super resolution enhancements, and (8) supplemental information from various types of very low cost non-infrastructure base stations for communicating via a typical commercial wireless base station infrastructure or a public telephone switching network. Accordingly, the traditional mobile station (“MS”) location difficulties, such as multipath, poor location accuracy and poor coverage are alleviated via such technologies in combination with strategies for: (a) automatically adapting and calibrating system performance according to environmental and geographical changes; (b) automatically capturing location signal data for continual enhancement of a self-maintaining historical data base retaining predictive location signal data; (c) evaluating MS locations according to both heuristics and constraints related to, e.g., terrain, MS velocity and MS path extrapolation from tracking and (d) adjusting likely MS locations adaptively and statistically so that the system becomes progressively more comprehensive and accurate indoors as well as outdoors. See for example U.S. Pat. No. 4,728,959 (Maloney et al), U.S. Pat. No. 5,043,736 (Darnell & al), U.S. Pat. No. 5,727,057 (Emery & al), U.S. Pat. No. 5,317,323 (Kennedy & al), U.S. Pat. No. 5,982,324 (Watters & al), U.S. Pat. No. 6,199,045 (Giniger & al), U.S. Pat. No. 5,815,538 (Grell & al).

Location-based information or content represents information about places and their events provided to users while taking into account their current or subsequent location; hence information that is a function of a specific location. At present, all the systems, applications and solutions basically make location-based information available to users of mobile devices as follows. Users access location-based information either through positioning systems that require that the users provide location information such as an intersection, a street address, a zip code or a combination of these elements, or through positioning systems that automatically detect the location of the users' devices. Whatever method is used to pinpoint the users' location, once it is known to the system, the latter provides location-based information, meaning information about places and their events in the vicinity of the users' current or subsequent location. See for example U.S. Pat. No. 5,682,525 (Bouve & al) and U.S. Pat. No. 5,926,116 (Kitano & al). However, the said location-based information is always created in advance, impersonal in nature, non-customizable nor personalizable, mainly of commercial nature such as restaurants, shops, ATMs, movie theatres, etc., and resides in a plethora of proprietary repositories.

The main drawback of these systems is that users of mobile devices are not enabled to create their own location-based content as they go along, thus forcing them to rely solely on location-based information originating from proprietary databases.

There exists on the market GPS equipment that allows users to create and locally store positioning coordinates (latitude/longitude/altitude) along with a short text description, for subsequent use. However, as regards storage, the said GPS equipment has limited memory space that implies limited creation of positioning information and thus subsequent limited access to the said information. Furthermore, the impossibility for the said GPS equipment to interact with a network prevents users from easily sharing with other users the positioning information they created as well as preventing the users from easily accessing positioning information created by other users. Finally, GPS equipment is useless indoors since the said equipment needs a line of sight with the satellites in order to function properly.

Accordingly, there is a need for a system that allows users and more particularly users of mobile devices to create personalized location-based information on the fly, along with related rich content, without memory limitations, that can be accessed and shared with other mobile users or wired computer systems in real-time or at a subsequent moment through communication networks. The object of this invention is to allow people to function closer to their personal or business interests by enabling them to easily create location-based information or content and to receive such information from family, friends, suppliers, clients or colleagues.

### SUMMARY OF THE INVENTION

The Location Bookmark System and Method relates to information communications between sources of geographical positioning data and related information, and one or more users who can also share information with other users or computer systems. Broadly stated, a Location Bookmark (“LBK”) pertains to data associated with places, physical objects and events that the mobile user may encounter or consider visiting. It particularly relates to places and events occurring in a locus accessible to the mobile user and that the user may arbitrarily choose to create, personalize and/or communicate to another user. Sources of location bookmarks include databases of local information and information input from users themselves. In other words, a LBK is a data object that corresponds to a place, a physical object or an event located on earth through a coordinates system (spherical coordinates, Cartesian system, etc.) and is comprised of embedded multimedia information (text, image, audio, video) as well as links to external resources (web sites, web services, databases, etc.).

The system enables to input, retrieve and share LBKs through distributed networks such as the Internet.

In an embodiment of the present invention, the location bookmark system and method consists of at least one mobile station with minimal computing capabilities, a transceiver for wireless voice and data telecommunications, an accessible network connected to a database server and one or more wireless positioning technologies (indoors and/or outdoors).

The present invention provides a system, method and data format to create, organize, retrieve, share and send location bookmarks between users connected to the Internet through wireless or wired devices.

This invention should prove useful to, for example, travelers who want to record and keep the itinerary of the places they visited during a trip. They would want to keep information about the hotels where they stayed, the friends they visited, the restaurants where they ate and the name of the owners, the museums they visited, the parks they went to, the golf courses they played and other events and attractions. While they record places they go to, they can save information such as if they were keeping a “digital ship log” of their trip. Afterwards, or even while they're traveling, travelers can share with fellow traveler, friends or business colleagues the places and related information they recorded while traveling. Accordingly, the logged information is much more personalized and customized than commercially available information from digital tourist guides or the like.

The system enables businesses (hotels, restaurants, museums, etc.) as well as organizations, individuals, etc. that supply LBK data to provide further information to users such as web services and/or products offered in relation to any particular LBK (mobile ticketing, reservation service, merchandise, inventory information, etc.), where applicable. Accordingly, users can include any one of these available products and services to the LBKs they create, as part of the latter. Users who create LBKs that are subsequently enriched by new products and services made available from businesses, organizations, persons, etc., can be notified so that they can include the said enhancements to the applicable LBKs that were created prior to the availability of these new products and services.

Thus, in addition to the possibility to create their own LBKs, as described above, users are enabled to access information from third parties that provide pre-packaged LBKs. Once the users access such information through the invention, they are enabled to save the said third-party LBKs and to modify them such as changing the text description, adding personal appreciation, etc.

The invention would also prove useful, for example, to a quality inspector who, while examining a construction site, would automatically receive information (blueprints, schedules, subcontractors involved, etc.) transmitted in real-time to his wireless device in accordance to his current position or any other particular point of the site. Among other things, the system enables the inspector to proceed to data captures (images, audio, video, etc.), to modify and encapsulate information in LBKs, to transmit the LBKs to various individuals or workgroups, all this in real-time. In addition, since the “location bookmarking” system can interact with project management configuration systems, it can alert the inspector in case of conflict, irregularity, anomaly, etc., once again in real-time. The inspector can also leave localized messages to concerned project members for subsequent “on the spot” visualization by the said project members.

Similarly, repairmen of various equipments (photocopiers, computer hardware and software, air-conditioning, etc.) can automatically obtain maintenance history as well as useful information regarding damaged equipment located throughout a building, whether the said information is provided by the equipment itself (through the Internet, the local area network, etc.) or by repairmen that previously performed maintenance work on the said equipment.

Objects and advantages of the location bookmark system and method:

Enables users of wireless devices to create and store LBKs in real-time (directly from where they are positioned), without the memory limitations inherent to known mobile devices, and to subsequently modify and personalize the said LBKs.

Allows personalized indexation of LBKs.

Provides mobile users with the ability to access personalized information they created relating to places, objects or events of interest and related information.

Enables the sharing of LBKs and the management of their access (such as read/modify/send authorizations) among system clients who are part of a same group.

Allows system clients to send LBKs amongst themselves and to modify LBKs received from others.

Allows to automatically or manually update the contents of LBKs.

Provides navigational information, such as area maps, 3D representations, directions, etc.

Provides services such as meeting points and location-based messaging.

Provides local or proximate information, at the users' request, according to the mobile users' present or subsequent location.

There is therefor provided a system for the creation and management of bookmarks relating to a location comprising:

a) a data server comprising;

i) processor means for processing data;

ii) means for encoding data elements relating to said location;

iii) means for storing said data elements on a storage medium;

iv) means for selectively accessing said data;

v) data transceiver means;

b) at least one user device;

c) a data communication network adapted to connect said user device to said data server.

In another aspect of the invention there is provided a virtual location bookmark for use with a system as described above in which the data elements are adapted to contain data representations of:

a) the geographical position of the location; and

b) an identifier associated with the location.

In yet another aspect of the invention there is provided a method for creating and storing information concerning a location comprising the steps of:

a) determining the geographical position of the location;

b) identifying or creating additional data associated to said location;

c) creating a record comprising said position and said additional data;

d) storing said record in a centralized database.

In yet another aspect of the invention there is provided a method for creating and storing information concerning a location comprising the steps of:

a) determining the geographical coordinates of the location;

b) identifying or creating additional data associated to said location;

c) storing said coordinates and said additional data in a centralized database.

Other aspects and many of the attendant advantages will be more readily appreciated as the same becomes better understood by reference to the following detailed description and considered in connection with the accompanying drawings in which like reference symbols designate like elements throughout the figures.

The features of the present invention which are believed to be novel are set forth with particularity in the appended claims.

### BRIEF DESCRIPTION OF THE DRAWINGS

The invention will be better understood and appreciated from following the description of illustrative embodiments thereof, and accompanying drawings, in which:

FIG. 1 is a schematic representation of a communication network used in association with the invention;

FIG. 2 is a schematic representation of an embodiment of the invention;

FIG. 3 is an example of data contained in a location bookmark in accordance with the invention;

FIG. 3a is an example of data structure contained in a location bookmark in accordance with the invention;

FIG. 4 is a logic flow diagram of the creation of a location bookmark in accordance with the invention;

FIG. 4a is another logic flow diagram relating to the creation of a location bookmark in accordance with the invention;

FIG. 5 is a logic flow diagram of the retrieval of a location bookmark in accordance with the invention;

FIG. 6 is a logic flow diagram of the sharing of a location bookmark in accordance with the invention;

FIG. 7 is a schematic representation of another communication network used in connection with the invention;

FIG. 8 is a schematic representation of another embodiment of the invention;

FIG. 9 is a schematic representation of another communication network used in connestion with the invention;

FIG. 10 is a schematic representation fo the use of the invention by a typical user;

FIG. 11 is a logic flow diagram showing the creation of a location bookmark in accordance with an embodiment of the invention;

FIG. 12 is a logic flow diagram showing the selection of location bookmark in accordance with an embodiment of the invention;

FIG. 13 is a representation of a location bookmark creation web page in accordance with an embodiment of their invention; and

FIG. 14 is a representation of a location bookmark transfer web page in accordance with an embodiment of their invention.

From the foregoing it can be seen that a location bookmark system and method has been described. It should be noted that the sketches are not drawn to scale.

Accordingly it is intended that the foregoing disclosure and showing made in the drawings shall be considered only as an illustration of the principle of the present invention.

### DETAILED DESCRIPTION OF AN EMBODIMENT OF THE INVENTION

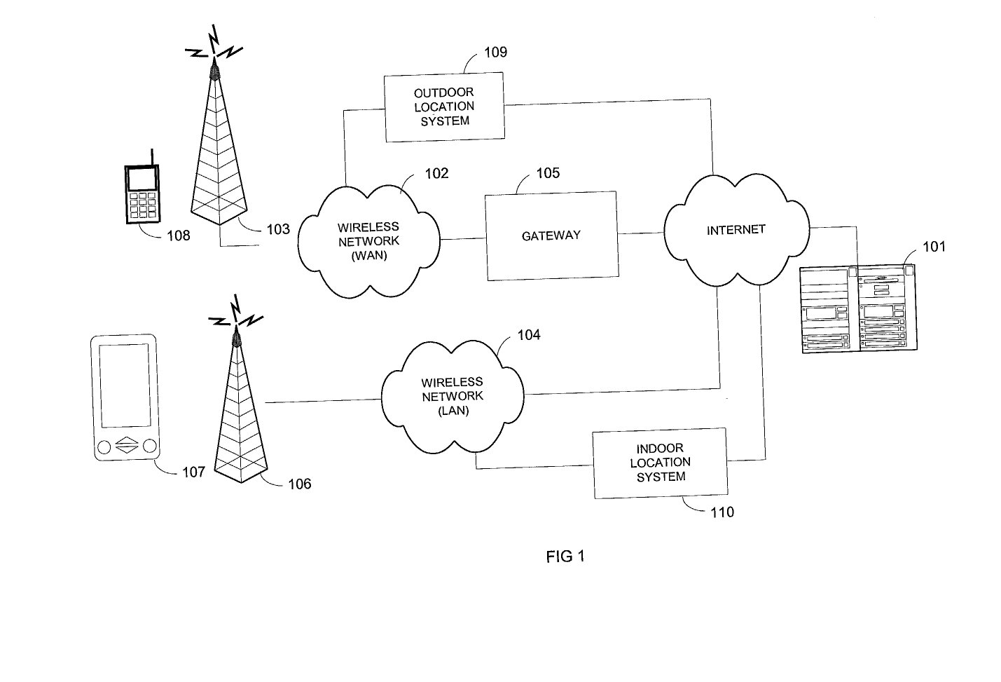

FIG. 1 illustrates the environment in which an embodiment of the invention operates where the said invention resides on a single Internet server (101). In another embodiment, it should be noted that the invention could be implemented in a distributed fashion using a group of public Web servers. As shown, the environment includes two kinds of wireless networks. The wireless WAN (102) is coupled to the Internet through a gateway while the wireless LAN (104) accesses the Internet directly. The two wireless networks include a significant infrastructure, only a portion of which is illustrated in FIG. 1. A component of the wireless WAN shown is a base transceiver station (103) that facilitates wireless communications between respective cells. A component of the wireless LAN shown is a wireless LAN access point (106). As shown, mobile units (107 & 108) may operate within the area served by one wireless network. Also shown are two systems (109 & 110) that enable to obtain the position of the mobile units. In such an embodiment of the invention, the Internet server (101) interacts with these systems in order to obtain the position of the mobile units (107 & 108).

The wireless WAN (102) connects to the Internet through the gateway (105). The gateway (105) serves to convert communications as they pass between the wireless network and the Internet. Coupled to the Internet are web servers that support communications through the Internet. Each of the mobile units supports communication with the Internet via compatible languages and protocols.

One particular protocol supported by the wireless WAN (102) is the Wireless Application Protocol (WAP) while one particular language supported is the Wireless Markup Language (WML). The Internet supports the Hypertext Transport Protocol (HTTP) and WML for communication between mobile units and the web servers. However, as is known, the Internet also supports communication in the Hypertext Markup Language (HTML). The gateway, among other operations in facilitating communication between the Internet and the wireless network, converts communications between WAP protocols stack and Internet protocols stack, the gateway supporting communications according to HTTP on its Internet connection and according to Wireless Transport Protocol (WTP) on its wireless Internet connection.

As regards the LAN wireless network (104), a gateway is not required since the said network uses Internet protocols. Communications between mobile units (107) on such a network (104) thus occur directly.

In the present embodiment of the invention, a server application interacts with different mobile units (108) through a gateway, or directly interacts with mobile units (107) through the Internet without a gateway. It should be noted that the present invention is not limited to any particular set of protocols such as WAP, HTTP, etc. For example, in another embodiment of the invention, the protocol used for communication in the WAN wireless network could be HDTP instead of WAP. In addition, the server application is not limited to using the HTTP protocol; for example, it could use proprietary application-level protocols coupled with compression algorithms to optimize wireless data transfers.

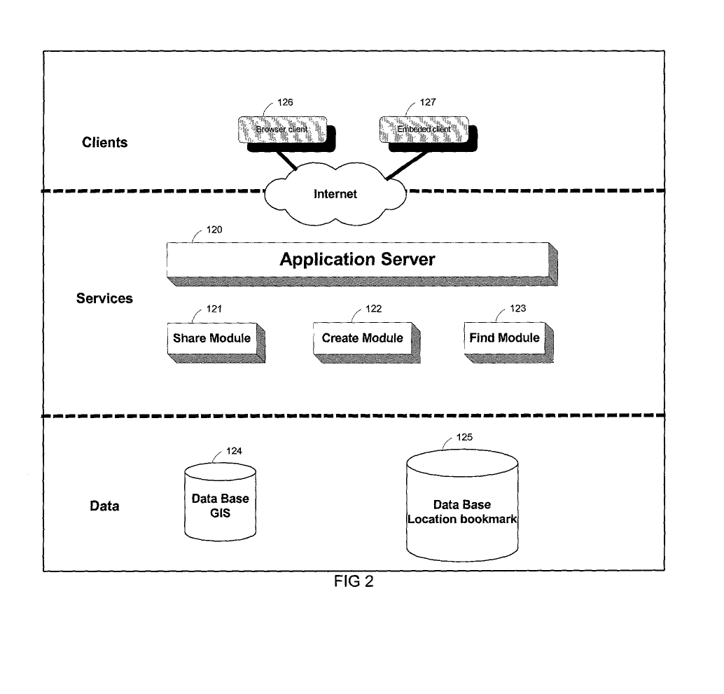

FIG. 2 illustrates the general architecture relating to the present embodiment of the invention. In FIG. 2, the application server (120) accomplishes two main tasks in order to answer client requests:

1—Recognizing and accounting for the characteristics of the different clients such as screen size, memory, processing power, bandwidth, etc.;

2—Calling the necessary operations from the applicable modules (121, 122, 123) to correctly answer requests (create LBKs, find LBKs, share LBKs) from any given client.

The system encompasses two databases (124, 125). The first of these databases (125) stores the users' LBKs while the second of these databases (124) stores GIS data which, among other things, is used to present maps, convert addresses in positioning coordinates (latitude/longitude/altitude), etc.

FIG. 2 also illustrates two types of client (126, 127). The browser client (126) is simply a WAP browser that doesn't perform any calculations. The WAP browser communicates, through the HTTP protocol, with the application server (120) that makes the necessary calculations before returning the results in WML format. The embedded client (127) communicates with the application server (120) through the SOAP protocol. It should be noted that the said client (127), when it holds enough memory, could directly process certain requests.

In a preferred embodiment of the invention, Extended Markup Language (XML) technologies are used in order to enable various types of clients (smart phones, PCs, PDAs, etc.) to access the invention, according to the various characteristics of the clients. This is done using Extensible Stylesheet Language (XSL) and Extensible Stylesheet Language Transformation (XSLT). XSL and XSLT that allow transforming and translating XML data from one XML format into another. XML is also used to communicate between the various components of a distributed system.

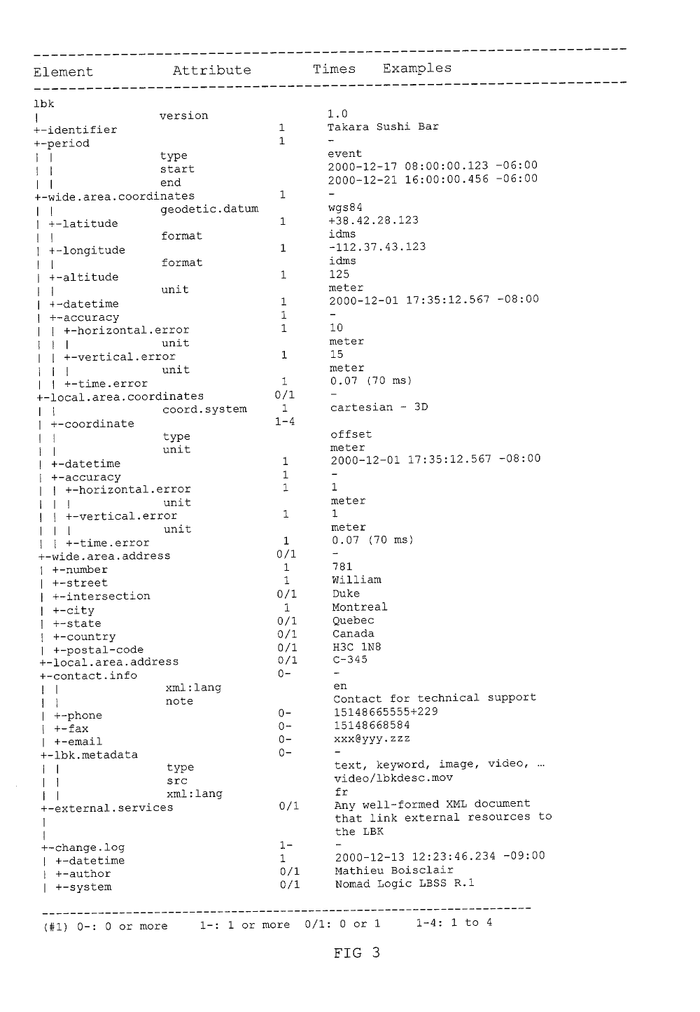

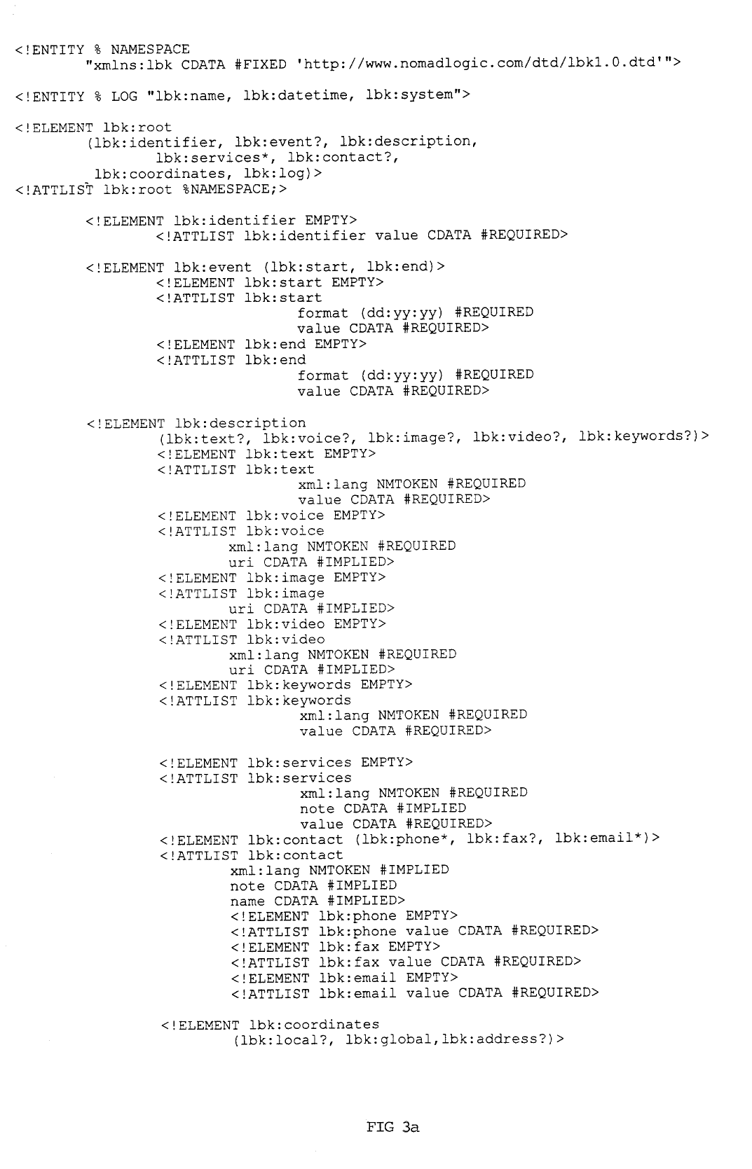

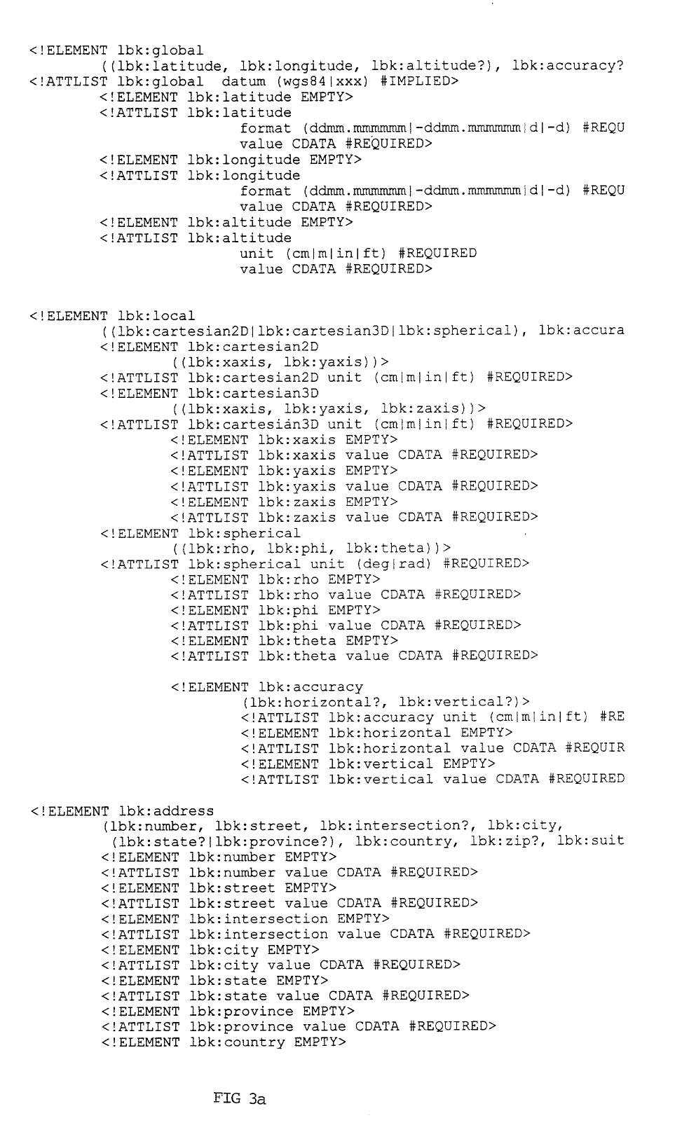

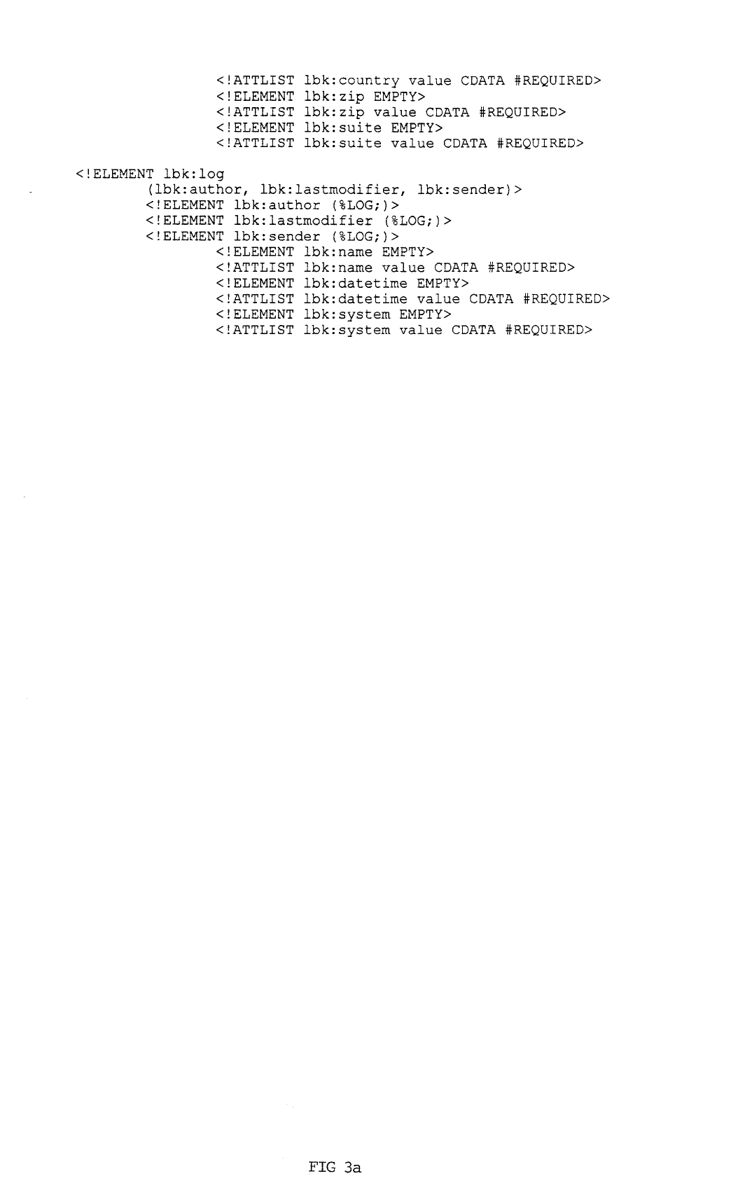

FIG. 3 illustrates the main fields of the LBK data format, based on the XML standard. The said LBK data format is flexible and is not limited to the structure presented in FIG. 3. The data type and definition (“DTD”), as described in FIG. 3, can be found at FIG. 3a.

The invention encompasses three main functions relating to geographical positioning data and related information: creating, finding and sharing.

Creating

In order to create a location bookmark, the invention must first obtain the geographical positioning data relating to the place, object or event for which the user wishes to save information. This first step can be split in two according to the context of creation of the location bookmark: either a user creates a location bookmark from the place where he stands at the moment of creation (live creation) or the user creates a location bookmark from a place other than the place where he is at the moment of creation (remote creation).

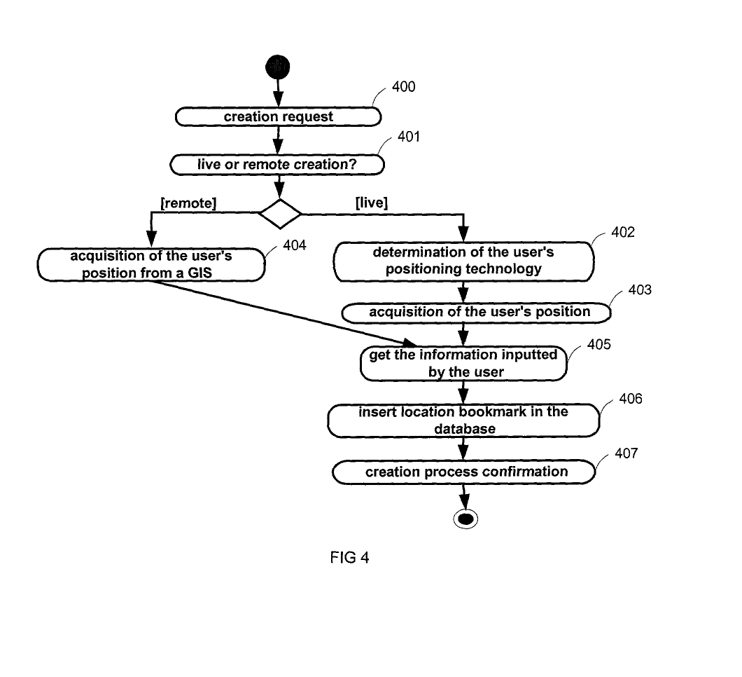

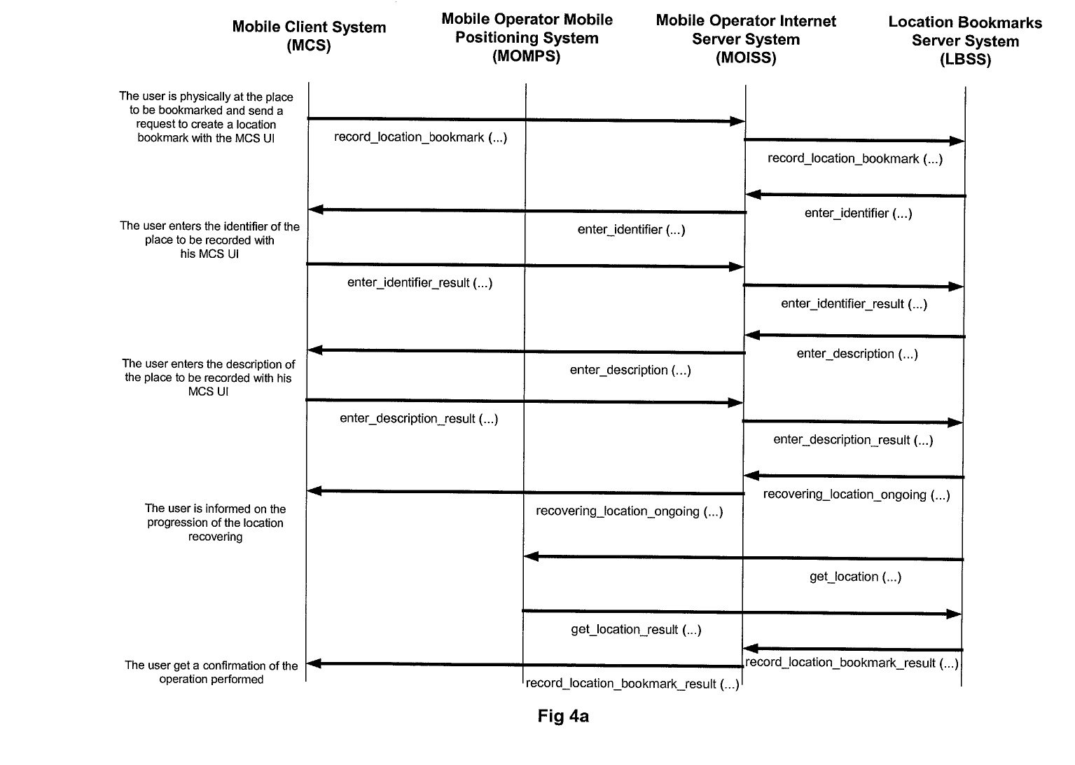

FIG. 4 illustrates the activity diagram related to the creation of a location bookmark. After having received a creation request (400), the system determines whether the creation of the LBK corresponds to live creation or remote creation (401). In the case of live creation, the invention first determines the positioning system to be used (402) to obtain the positioning coordinates of the mobile station (ex. GPS, TOA, E-OTD, etc.). In accordance with the technology used, the system then communicates with the said positioning system and obtains the position of the user (403). In the case of remote creation, the geographic position is obtained (404) by asking the user to select the geographic position of the LBK through the use of a Geographic Information System (GIS) server. For example, this can be done by using a mouse to pinpoint the position of the LBK the user wants to create on a map (provided by the GIS server).

Once the geographic position of the place, object, event, etc. has been identified, the user may input related information such as a description (text, image, audio, video, etc.), search keywords, personal notes, start and end date in the case of an event, etc. Where applicable, the invention automatically acquires information that is also part of the LBK such as the date of creation, the name of the author, the accuracy of the geographic position, the street address (through the GIS server), etc. The data acquired is then streamed or sent through the network to the application server (405) that rearranges the information accordingly and stores it in a central database (406) so as to subsequently allow the user to easily access the said data. The system finally sends to the user a confirmation as regards the creation process (407).

FIG. 4a illustrates possible sequence of action performed to create a location bookmark. The Mobile Client System (“MCS”) is connected to the Location Bookmark Server System (“LBSS”) through the Mobile Operator Internet Server System (“MOISS”) which allows mobile devices to access internet. When the user is physically at the place he wants to create an LBK, the user sends a request via the MCS User Interface (“UI”) to the LBSS. The user enters the identifier and the description of the place, object or event. Then the LBSS interact with Mobile Operator Mobile Positioning System (“MOMPS”) which interacts with the MCS to retrieve the precise location of the user in the appropriate coordinate system. The location bookmark is created in the user database and the result of the operation is sent to the MCS.

LBKs so created are indexed by the user in accordance with a data structure that can be personalized to reflect his preferences. In the present embodiment of the invention, this is realized through the system that offers the user the possibility to create directories and sub-directories before selecting in which of these the LBKs created shall be inserted.

The sequence in which the operations are performed may vary; for example, the invention could obtain the geographic position only once the related information has been inputted. Furthermore, data regarding the related information of a LBK could be sent to the server separately or all at once (batch) according to the characteristics of the client device used.

Finding

Users can access three types of LBKs:

1—LBKs created by the user;

2—LBKs the user received from other users;

3—LBKs made available by other users.

There are various means by which users can find LBKs. Users may find LBKs directly by browsing through their personal folders, starting from the root directory and making their way through the directories and sub-directories down to the point where they can select the desired LBK. At any stage of the browsing process, whether directly in the root directory or in any other sub-directory, users may specify parameters such as radius, keywords, time available to reach destination, means of transportation, etc., so as to further refine their search.

FIG. 5 illustrates the activity diagram associated with this system functionality. When a request to access LBKs is received by the system (500), it presents to the user the content of the root directory (501). The user then selects a directory (502) so as to ascertain its content: either one or more sub-directories or LBKs, which the user can then select. Where the user selects a sub-directory for visualization (502), its content is presented to him by the system. The user may repeat this operation so as to browse through the data structure until he finds the desired LBK. Where the user selects a LBK (506), its details are presented to the user on the device's screen (507).

When the user selects to visualize the contents of a directory, as described above, the server responds in accordance with the characteristics of the device used by the user. For example, in the case of a device having limited memory space, the server will only send the data that can be kept in memory at once. The remainder of data, where applicable, is sent to the users' devices by way of another request to the server.

In the course of the browsing process described above, users may refine their LBK search by performing “find” requests that specify precise search criteria applicable to specific directories or sub-directories. In a preferred embodiment of the invention, the user can specify the radius of the area in which he wants to obtain LBKs, with the physical position of the device used acting as the central point of the said area. The user can also use another LBK as a central point for the search area. For example, if he enters a radius of 250 meters, the system will display all LBKs within a distance of 250 meters from where the device used is located. In order to perform this, the server identifies the position of the device used, as described earlier under “Marking”. Using this information, the server makes the necessary calculations in order to make the database query to obtain the LBKs identified within the specified area (505). The system then initiates the search in accordance with the specified search criteria and returns the applicable LBKs to the user. Once the list of LBKs is displayed, the user can select any one of them for visualization (506). The selected LBK is then either loaded onto the device's memory and the client can access it and have it displayed (507) on the device's screen directly, or the selected LBK is accessed from the server that can then send it (507) to the device in accordance to the device's characteristics and in the appropriate format (WML, XHTML, PDF, VoiceXMLetc.).

Once the chosen LBK is displayed on the device's screen, the user can then access the various fields of the LBK format (FIG. 3). In addition, the user can then access various services such as:

Sending the LBK to other users (see below);

Maps;

Directions (driving, walking, public transport, etc.);

Web services (buying tickets, getting information and schedules, etc.);

Etc.

It should be noted that the retrieval of LBKs from the server database is not limited to the method described above and that any other method could be used in order to enable users to find LBKs in an optimal fashion.

Sharing

In the present embodiment of the invention, users are provided with two means by which they can share location bookmarks: by sending copies of LBKs or by sending a reference to the LBK the users wish to share.

Under the first method (LBK copying), the user receives a complete copy of the LBK and has all the rights (read/modify/send) attached to the LBK received. Even if the user modifies the LBK received, the original LBK from which it originates remains unchanged.

Under the second method (LBK referencing), the receiving users share the same LBK as the user sending the LBK. A modification to the said LBK by any user will affect all the other users sharing that LBK in the sense that, once modified by any of these users, the LBK is modified for all the users who have access to that LBK. When LBKs are shared under the present method (LBK referencing), the sending user can choose to grant certain rights to the receiving users in relation to the one or more LBKs sent. In the present embodiment of the invention, the rights that can be granted by the sending users are the right to read the LBK, the right to add and/or modify the content related to the LBK and the right to send the LBK to other users. It should be noted that the right to send the LBK to other users is limited to at least the same restrictions as those attached to the LBK received. For example, user A sends a LBK to user B and the rights granted with respect to the said LBK are the right to read the LBK and the right to send the LBK but not the right to add and/or modify the content related to the LBK. If user B sends the LBK to user C, user B can only limit the rights granted in respect to the LBK, for example preventing user C from sending the LBK to any other user. Accordingly, user B cannot grant rights relating to the LBK that he didn't have himself.

There are multiple possible implementations of the sharing functionality. In the present embodiment of the invention, three possible implementations are hereby presented, as regards sharing LBKs:

1—By using protocols such as SMTP, SMPP and IMPP, with one or more LBKs as an attachment or with an URL in the message body that grants access to one or more LBKs for further copying or referencing, as described above;

2—When two or more users have access to the same server or when the servers to which the said users have access are part of the same distributed system, then the LBKs are shared (LBK copying or LBK referencing) from one user to the others directly through the server database;

3—By using the Simple Object Access Protocol (“SOAP”); in this case, a client device makes a request to the server that includes one or more LBKs along with the recipient's identification. The server then makes the appropriate changes to the database (LBK copying or LBK referencing) or directly sends the LBKs to the recipient's SOAP client (LBK copying).

4—By using a Location Bookmark Tag (“LBT”). An LBT is a small footprint software application (or an URL) that can easily be integrated to another application as an anchor to the location bookmark(s) made available by a third-party. For example, a LBT can be a Java Applet that is available through a 3-party web site. When Internet users access the page where a LBT is available, he can activate it to be automatically connected to the LBSS which host the LBKs concerned by the LBT after an access control sequence.

5—By using protocols such as Bluetooth and IrDA, with one or more LBKs as an attachment, copies of LBKs can be beam from one user to other(s). In this case, copies of LBK are stored locally into the wireless device and can be easily synchronized with the user central database through protocol such as SyncML.

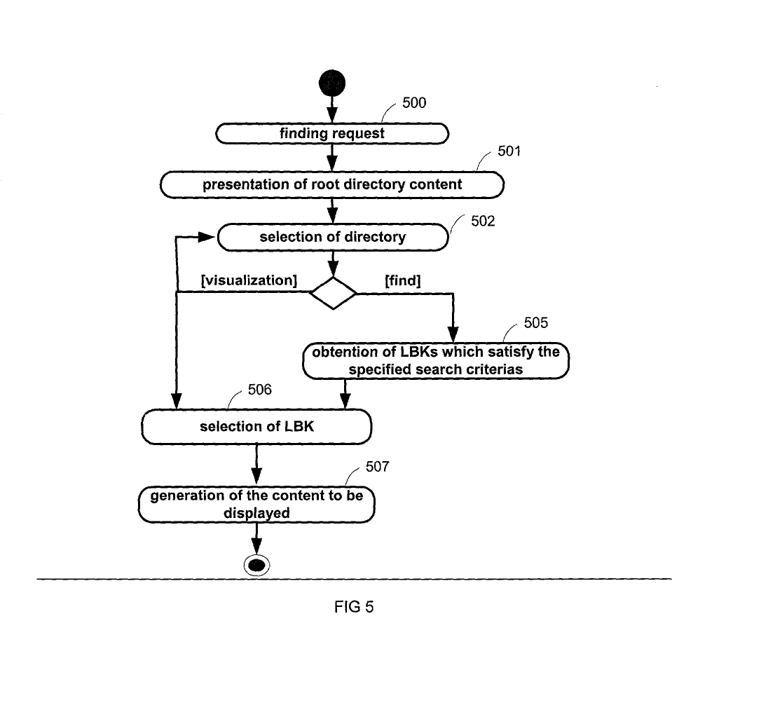

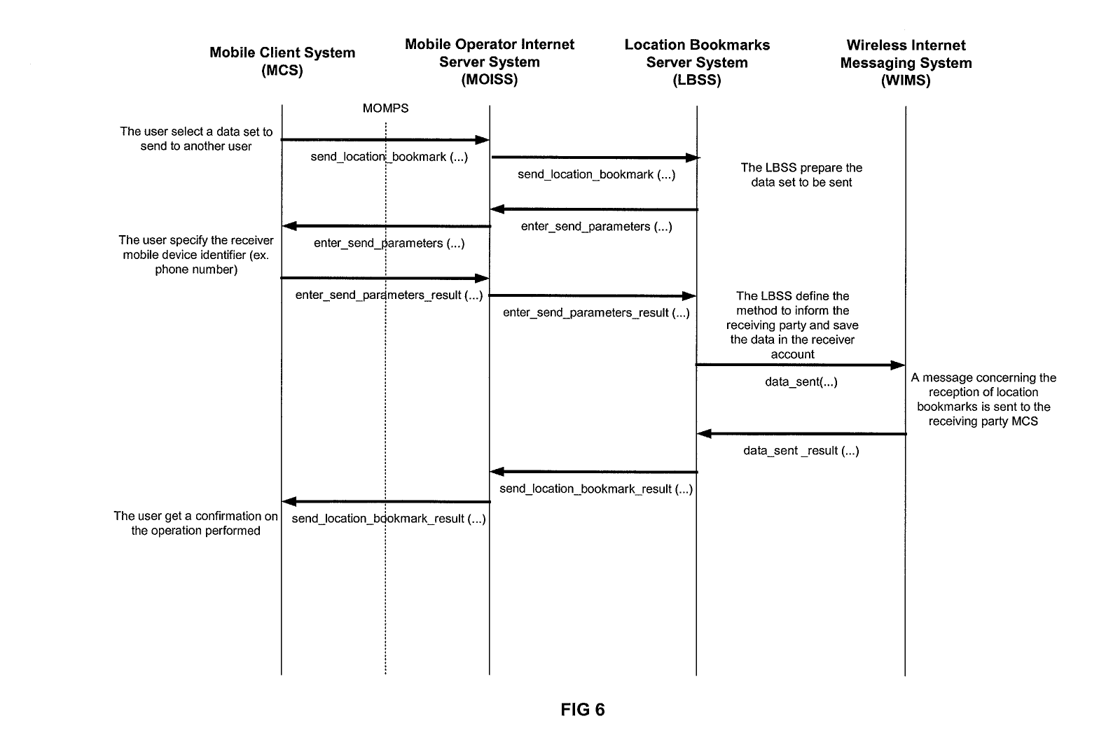

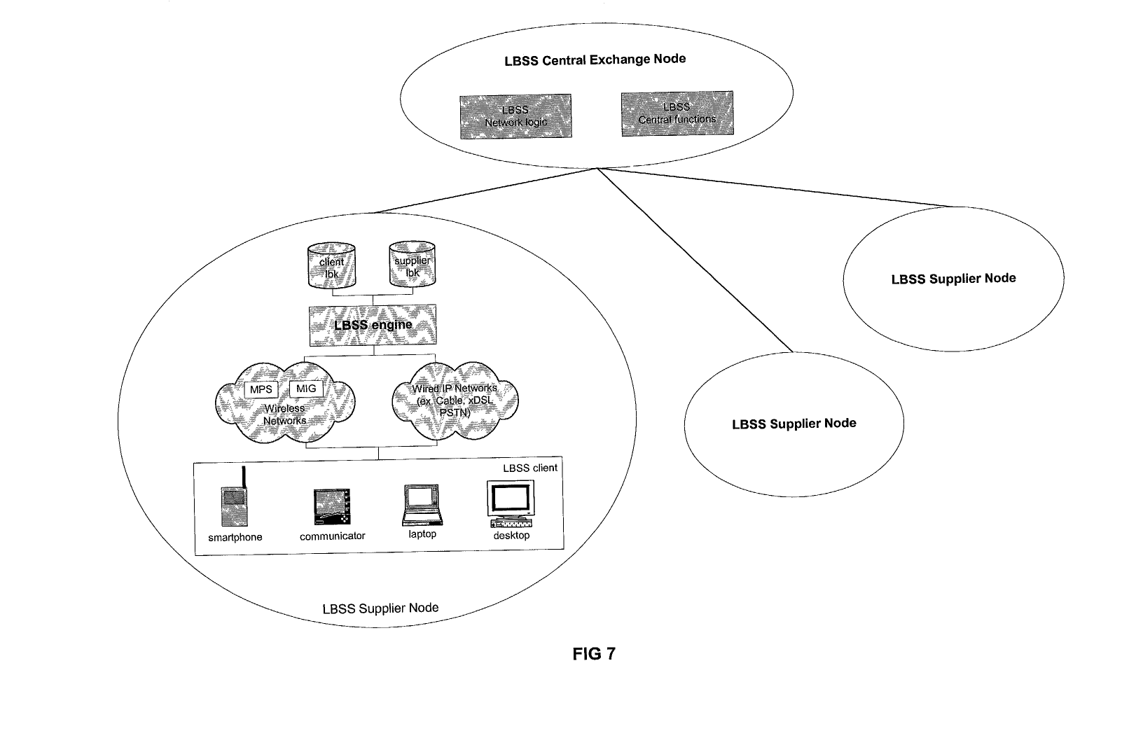

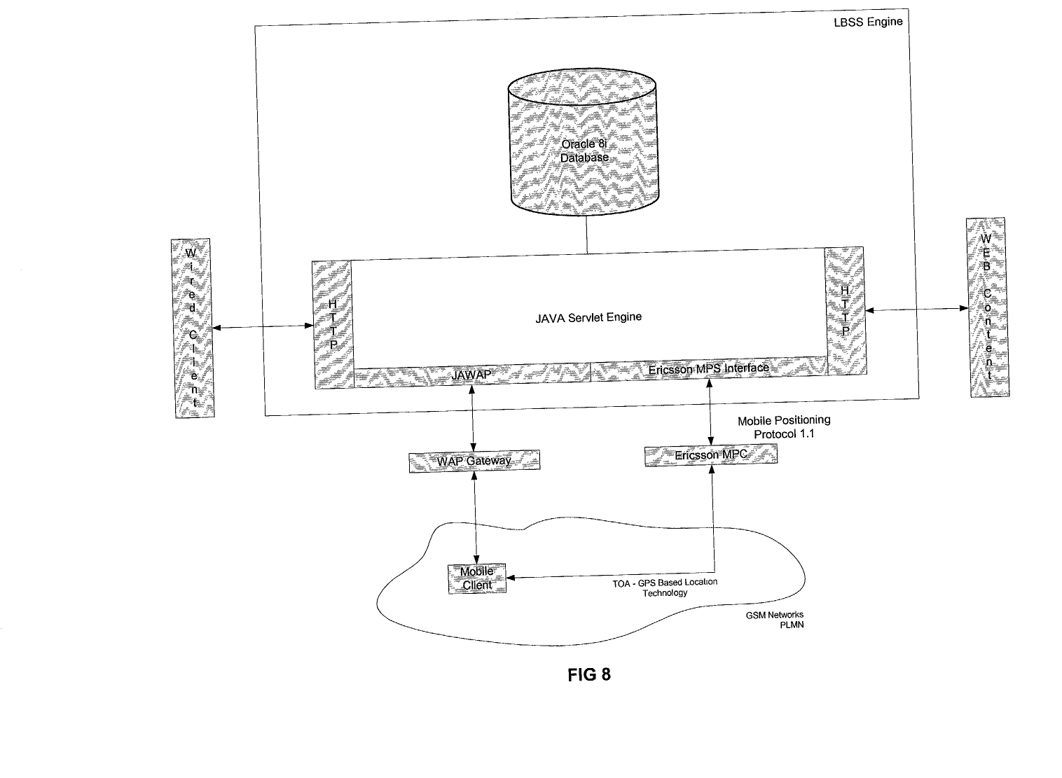

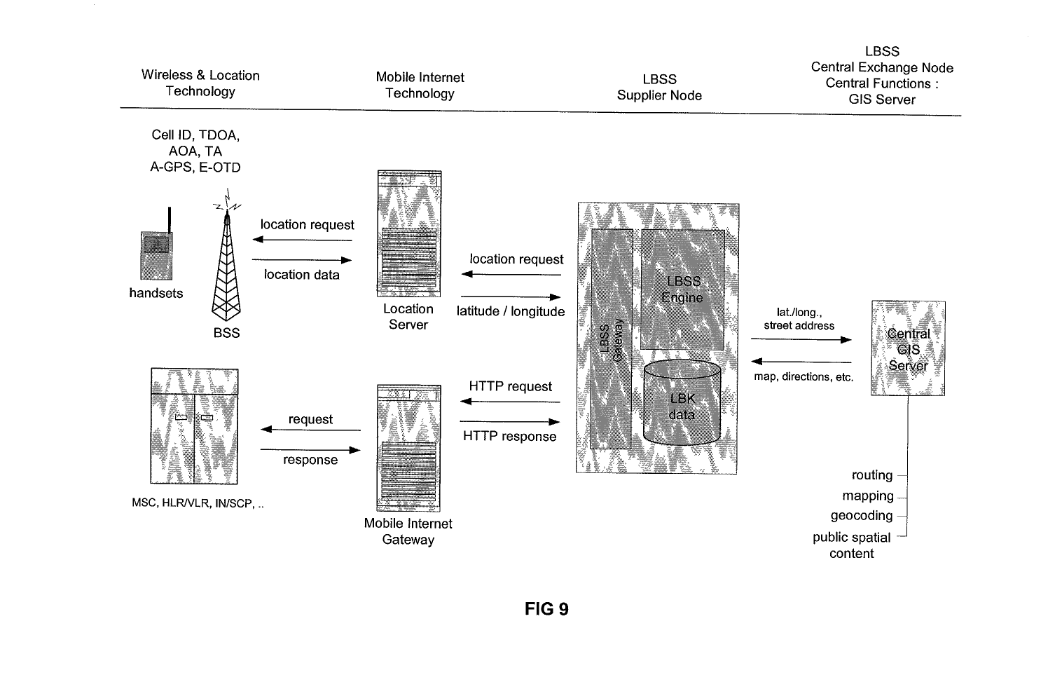

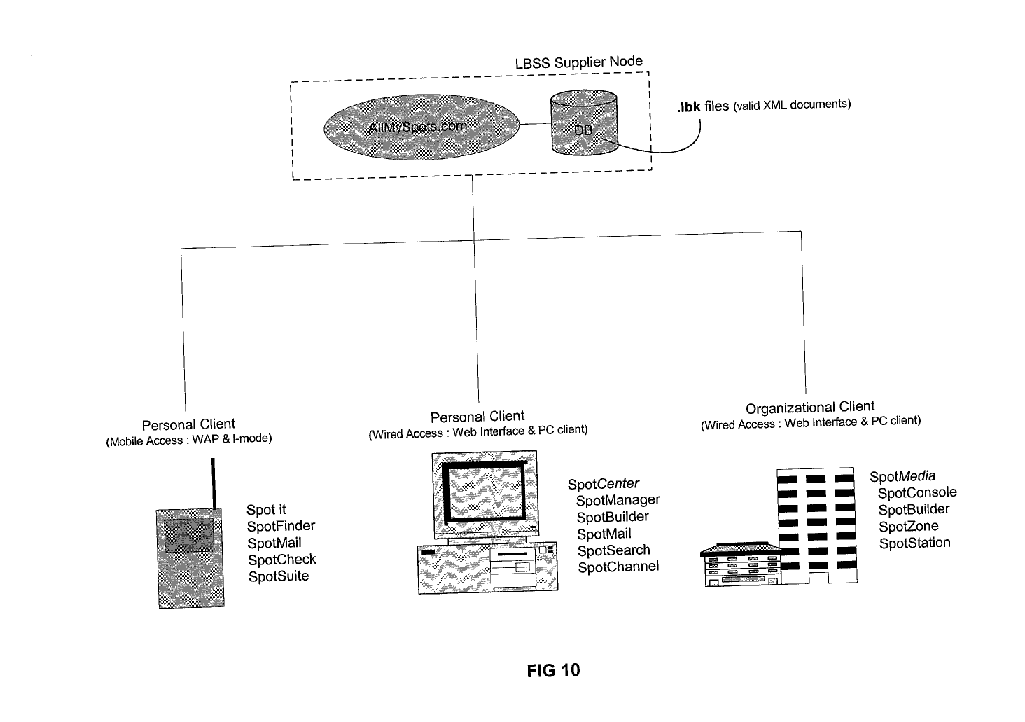

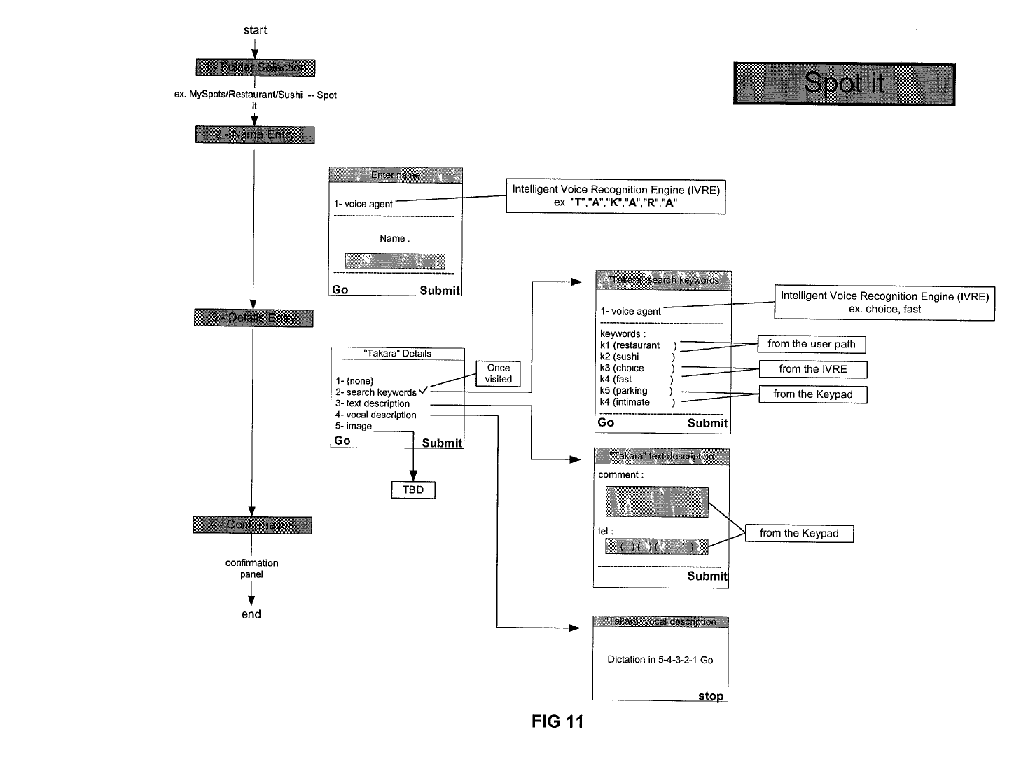

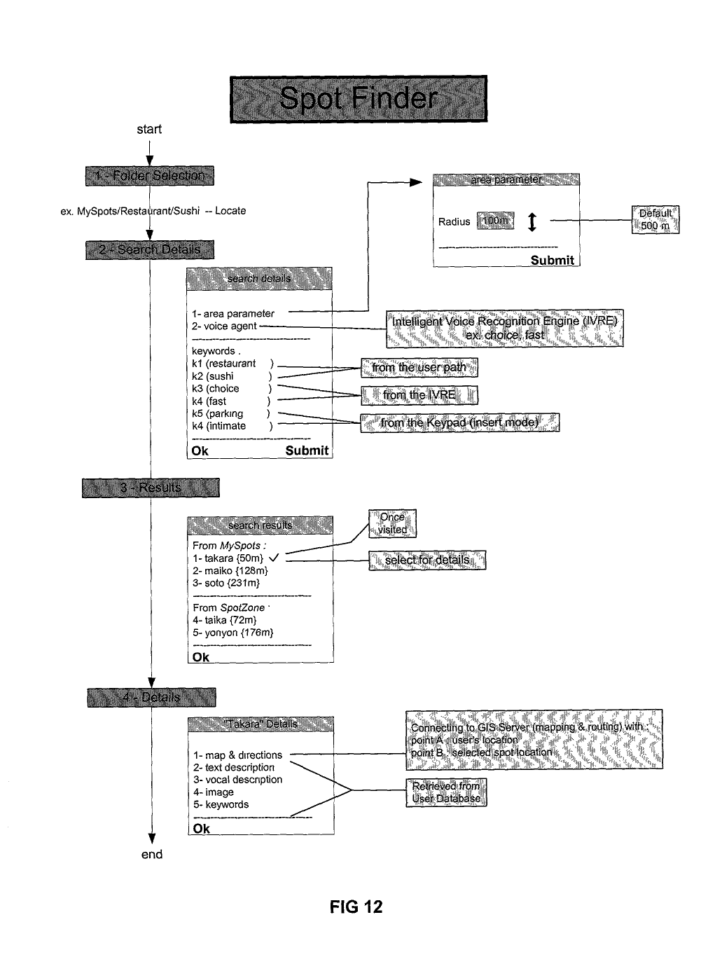

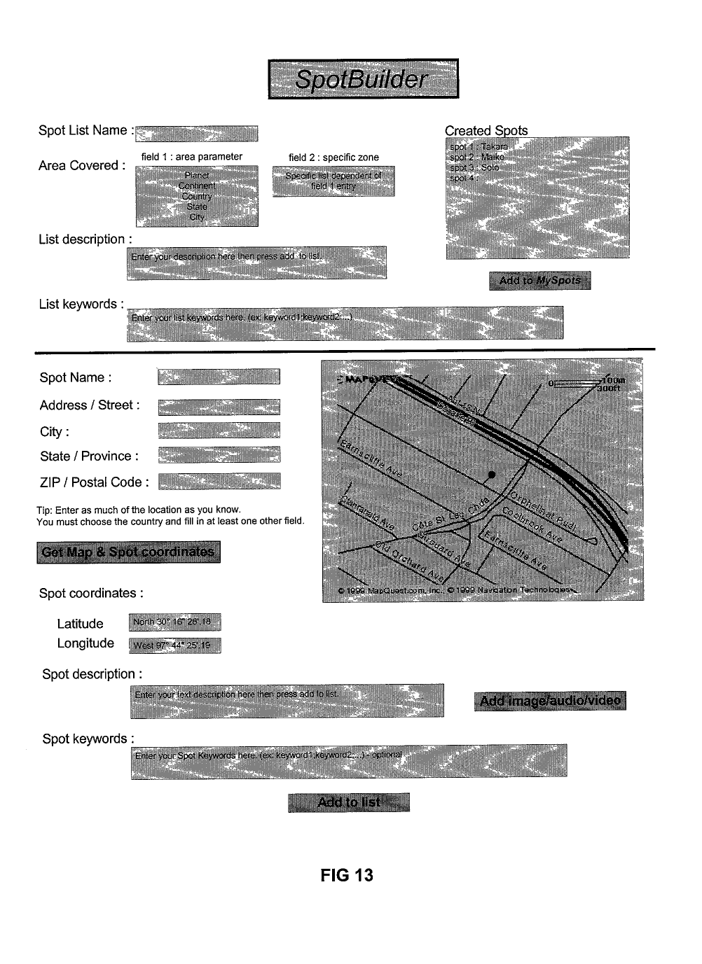

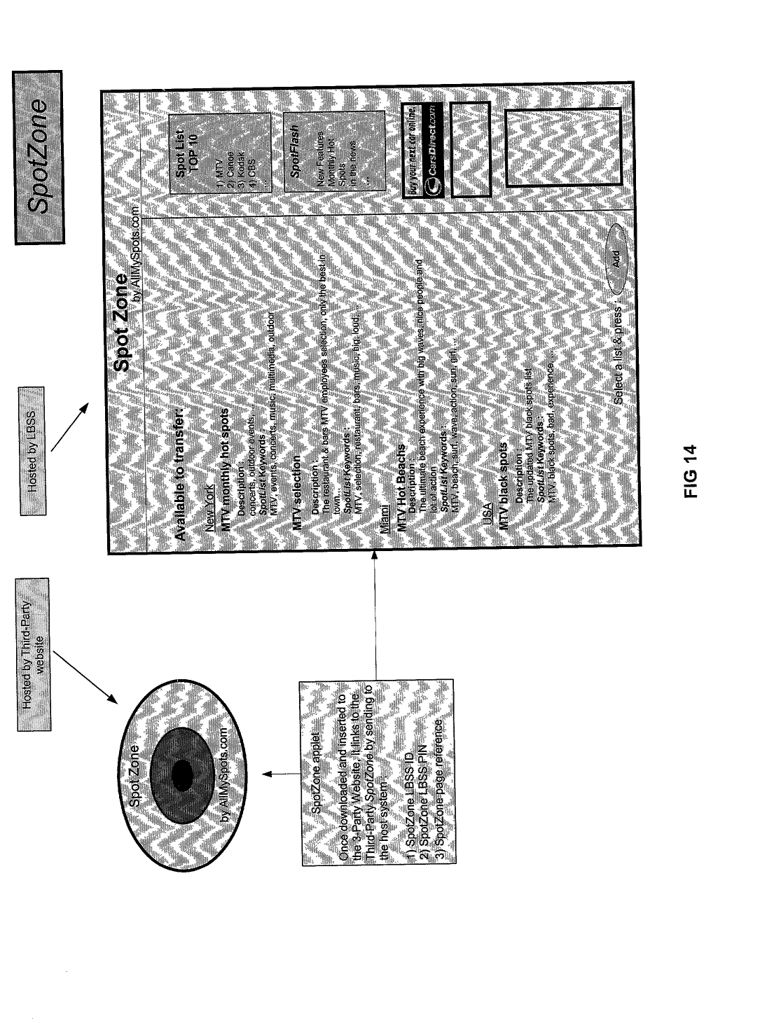

FIG. 6 illustrates a possible sequence of actions performed to send a location bookmark or a subset of location bookmarks to another MCS as described above (method 2). The user navigates the location bookmarks available for sending and selects a subset of data to be sent to another user. Then the user sends a request through his MCS to the LBSS which prepare the data to be sent. The user enters the parameters needed to identify the receiver (ex. phone number). The LBSS informs the receiving party and save the data in the receiver account. The sending agent is then notified about the operation completion.

While the preferred embodiments shown and described are fully capable of achieving the object of the present invention, these embodiments are shown and described only for the purpose of the illustration and not for the purpose of limitation, and those skilled in the art will appreciate that many additions, modifications and substitution are possible without departing from the scope and spirit of the invention as defined in the accompanying claims. For example, any other method, communication or transport protocols could be used to share LBKs among users and that the above three means for sharing LBKs are supplied for information purposes only.

What is claimed is:

1. A system for the creation and management of bookmarks relating to a location comprising:
a) a data server comprising;
i) processor means for processing data;
ii) means for encoding data elements relating to said location;
iii) means for storing said data elements on a storage medium;
iv) means for selectively accessing said data;
v) data transceiver means;
b) at least one user device;
c) a data communication network adapted to connect said user device to said data server.

2. A system as claimed in claim 1 in which the data elements are adapted to contain data representations of:
a) the geographical position of the location; and
b) an identifier associated with the location.

3. A system as claimed in claim 2 in which the geographical position data elements comprise:
a) the latitude associated with the location; and
b) the longitude associated with the location.

4. A system as claimed in claim 2 wherein said identifier is one or more of the following:
a) a text;
b) a video recording;
c) an audio recording; and/or
d) an image.

5. A system as claimed in claim 3 further comprising data elements which are adapted to contain data representations of the altitude associated with the location.

6. A system as claimed in claim 4 further comprising data elements which are adapted to contain data representations of the identification of the author of the bookmark.

7. A system as claimed in claim 6 further comprising data elements which are adapted to contain data representations of the accuracy of the data representations of the latitude, the longitude and the altitude.

8. A system as claimed in claim 1 in which the data elements are adapted to contain data representations of:
a) the latitude associated with the location;
b) the longitude associated with the location;
c) an identifier associated with the location; and
d) the altitude associated with the location.

9. A virtual location bookmark for use with a system as described in claim 1 in which the data elements are adapted to contain data representations of:
a) the geographical position of the location; and
b) an identifier associated with the location.

10. A virtual bookmark as claimed in claim 10, wherein the geographical position data elements comprise;
a) the latitude associated with the location; and
b) the longitude associated with the location.

11. A virtual location bookmark as claimed in claim 10, further comprising the latitude associated with the location;

12. A method for creating and storing information concerning a location comprising the steps of:
a) determining the geographical position of the location;
b) identifying or creating additional data associated to said location;
c) creating a record comprising said position and said additional data;
d) storing said record in a centralized database.

13. A method as claimed in claim 12 wherein the said record is created by the user of a wireless device.

14. A method as described in claim 12 wherein said record is created by the user of a wired computer.

15. A method as claimed in claim 13 wherein said wireless device is a cellular telephone.

16. A method as claimed in claim 12 wherein said record is created by the user of a browser based light client.

17. A method for creating and storing information concerning a location comprising the steps of:
a) determining the geographical coordinates of the location;
b) identifying or creating additional data associated to said location;
c) storing said coordinates and said additional data in a centralized database.

18. A method as claimed in claimed 12 wherein said coordinates are determined with the use of a GPS device.

19. A method as claimed in claimed 17 wherein said coordinates are determined with the use of a GPS device.

20. A method as claimed in claim 19 wherein said GPS device is integrated to a wireless communication device.

21. A method as claimed in claim 20 wherein said wireless communication device is a cellular telephone.

22. A method for the management of a record created pursuant to the method claimed in claim 12, comprising the steps of:
a) accessing the database over a communication link using a wireless device;
b) selecting said record in the database;
c) communicating said record over said communication link to the user of said wireless device.
